(19) United States
(12) Patent Application Publication
(10) Pub. No.: US 2026/0036459 A1
(43) Pub. Date: Feb. 5, 2026

(54) FUNNELING SCOOP APPARATUS

(71) Applicant: Braxton Daws, Mount Vernon, IN (US)

(72) Inventor: Braxton Daws, Mount Vernon, IN (US)

(21) Appl. No.: 18/794,820

(22) Filed: Aug. 5, 2024

(51) Int. Cl. G01F 19/00; A47J 43/28

(52) U.S. Cl. CPC G01F 19/002; A47J 43/28

(57) ABSTRACT

A scoop apparatus for funneling substances and storing on rims of containers includes a handle which is elongated between a first end and a second end. A bowl is coupled to the handle at the second end thereof and defines a cavity which faces upwardly with respect to the handle. The bowl has a rim defining a bowl opening to the cavity. A funnel is selectively mountable to the bowl and tapers from a receiving end to a dispensing end. The funnel defines a channel which extends through the receiving end and the dispensing end. The channel is in fluid communication with the cavity of the bowl when the funnel is mounted to the bowl. A width of the dispensing opening is smaller than a width of the bowl opening of the bowl.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to scoops and more particularly pertains to a new scoop for funneling substances and storing on rims of containers.

### (2) Description of Related Art Including Information Disclosed Under 37 CFR 1.97 and 1.98

The prior art relates to scoops and discloses myriad scoops with a detachable funnel to facilitate scooping substances with a wide mouth then depositing the substances with a relatively narrower mouth. However, the prior art fails to describe such an apparatus in which the funnel attaches to the scoop via a twisting connection. The prior art further fails to describe such an apparatus in which tabs of the scoop extend outwardly to seat the scoop on a rim of a container, thereby preventing the scoop from falling into a reservoir of the container which holds a powder or other substance.

### BRIEF SUMMARY OF THE INVENTION

An embodiment of the disclosure meets the needs presented above by generally comprising a handle which is elongated between a first end and a second end and has a bottom side and a top side which extend from the first end to the second end. A bowl is coupled to the handle at the second end thereof and defines a cavity which faces upwardly with respect to the handle. The bowl has a rim defining a bowl opening to the cavity. A funnel is selectively mountable to the bowl and tapers from a receiving end to a dispensing end. The funnel defines a channel which extends through the receiving end and the dispensing end, thereby defining a receiving opening at the receiving end and a dispensing opening at the dispensing end. The channel is in fluid communication with the cavity of the bowl when the funnel is mounted to the bowl. A width of the dispensing opening is smaller than a width of the bowl opening of the bowl.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a scoop apparatus according to an embodiment of the disclosure.

FIG. 2 is a rear exploded perspective view of an embodiment of the disclosure.

FIG. 3 is a bottom exploded perspective view of an embodiment of the disclosure.

FIG. 4 is a detail view of a funnel of an embodiment of the disclosure taken from Window 4 in FIG. 3.

FIG. 5 is a perspective view of an embodiment of the disclosure in a storage position with respect to a container.

FIG. 6 is an in-use view of an embodiment of the disclosure in which a scoop is collecting an amount of a substance from a container.

FIG. 7 is an in-use view of an embodiment of the disclosure depositing a substance into a vessel.

### DETAILED DESCRIPTION OF THE INVENTION

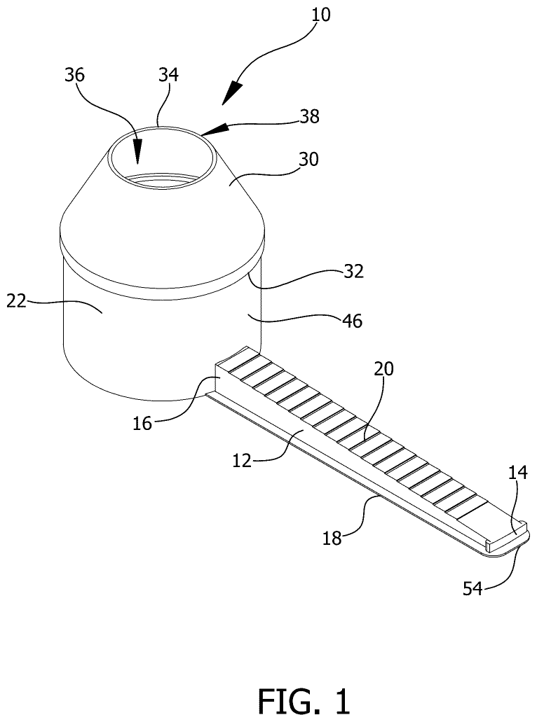

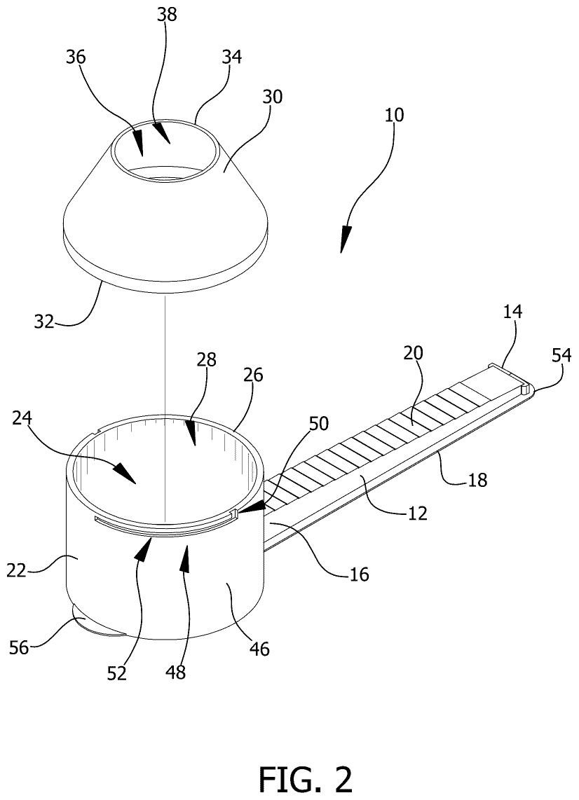

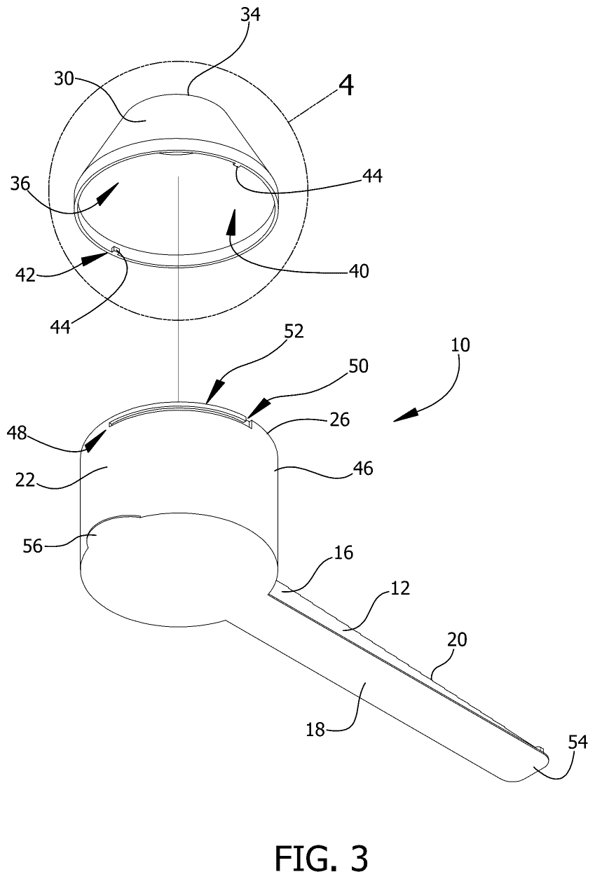

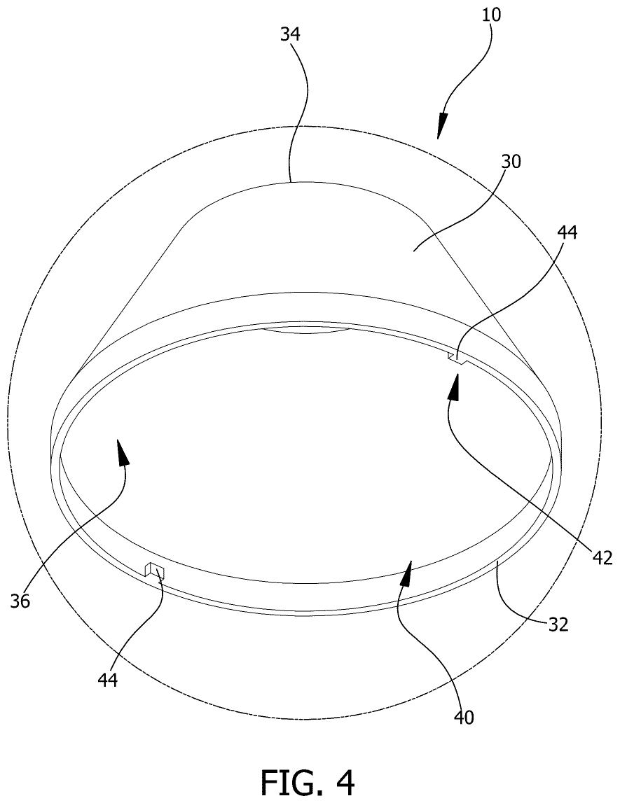

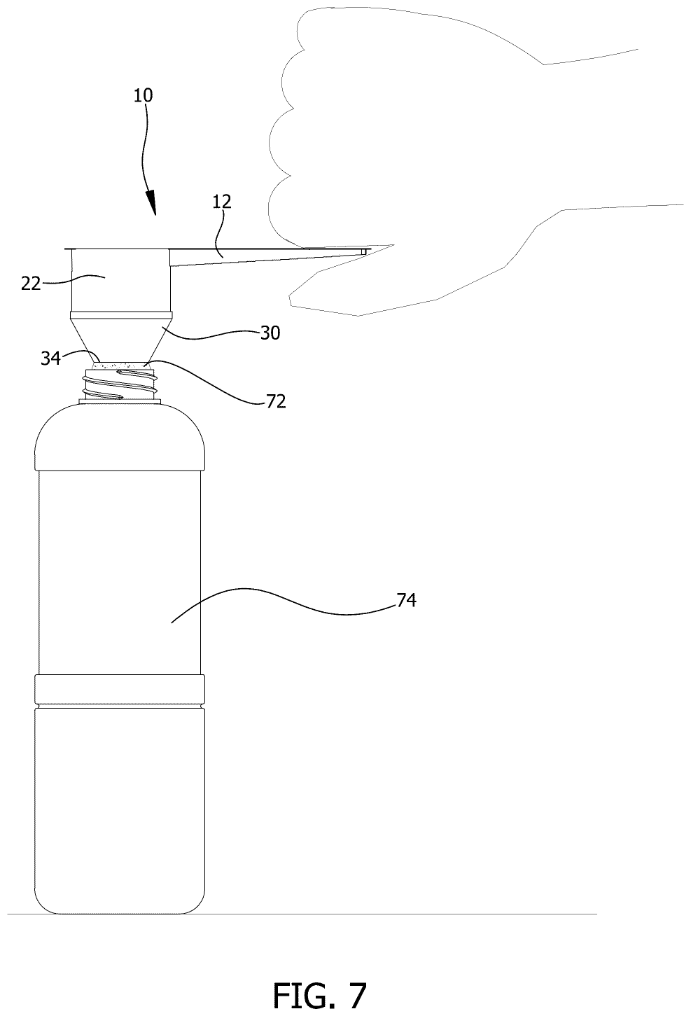

With reference now to the drawings, and in particular to FIGS. 1 through 7 thereof, a new scoop embodying the principles and concepts of an embodiment of the disclosure and generally designated by the reference numeral 10 will be described.

As best illustrated in FIGS. 1 through 7, the scoop apparatus 10 generally comprises a handle 12 which is elongated between a first end 14 and a second end 16. The handle 12 has a bottom side 18 and a top side 20 which extend from the first end 14 to the second end 16. A bowl 22 is coupled to the handle 12 at the second end 16 thereof and defines a cavity 24 which faces upwardly with respect to the handle 12. The bowl 22 is cylindrical in shape with a rim 26 which defines a bowl opening 28 to the cavity 24.

A funnel 30 is selectively mountable to the bowl 22. The funnel 30 tapers from a receiving end 32 to a dispensing end 34 and defines a channel 36 which extends through the receiving end 32 and the dispensing end 34. The funnel 30 defines a dispensing opening 38 at the dispensing end 34 and a receiving opening 40 at the receiving end 32. The channel 36 is in fluid communication with the cavity 24 of the bowl 22 when the funnel 30 is mounted to the bowl 22, and a width of the dispensing opening 38 is smaller than a width of the bowl opening 28 of the bowl 22.

The funnel 30 may be secured to the bowl 22 via a retainer 42 which is coupled to the funnel 30. The retainer 42 comprises a pair of securement tabs 44 positioned at the receiving end 32 of the funnel 30. The securement tabs 44 extend inwardly of the funnel 30 and engage slots 48 formed in an exterior surface 46 of the bowl 22 to secure the funnel 30 to the bowl 22. The securement tabs 44 are positioned opposite each other across the receiving opening 40. Each slot 48 has a radial portion 52 and a vertical portion 50. The vertical portion 50 extends vertically with respect to the handle 12 and is open at the rim 26 of the bowl 22. The radial portion 52 extends radially around the bowl 22. To secure the funnel 30 to the bowl 22, the funnel 30 is moved such that the securement tabs 44 insert into the vertical portions 50 of the slots 48. Then the funnel 30 is rotated to move the securement tabs 44 along the radial portions 52 of the slots 48. The edges of the radial portions 52 of the slots 48 prevent the funnel 30 from disconnecting from the bowl 22 when the scoop apparatus 10 is inverted.

A first support tab 54 and a second support tab 56 are provided for supporting the scoop apparatus 10 over a container 58. The first support tab 54 is coupled to the handle 12 at the first end 14, and the second support tab 56 is coupled to the bowl 22 opposite the handle 12. The first and second support tabs 54, 56 extend in opposite directions from each other. The first support tab 54 is inset from the top side 20 of the handle 12, and the second support tab 56 is inset from the rim 26 of the bowl 22.

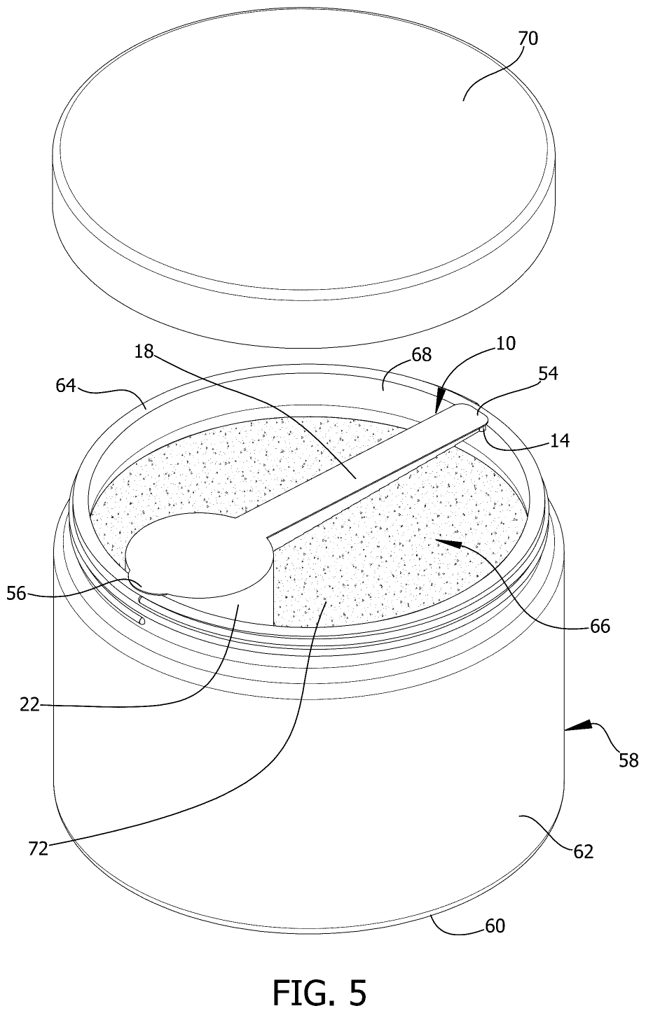

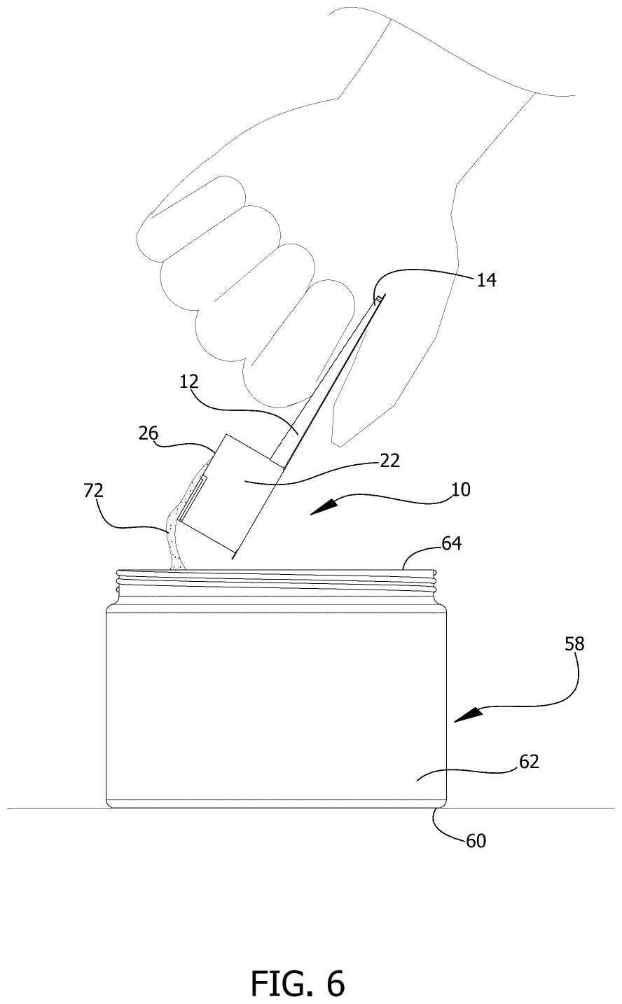

With reference to FIGS. 5 and 6, the container 58 may have a bottom wall 60 and a perimeter wall 62, in which the perimeter wall 62 is coupled to and extends upwardly from the bottom wall 60 to a top edge 64. The container 58 defines a reservoir 66 surrounded by the bottom wall 60 and the perimeter wall 62, the reservoir 66 is configured to store a substance 72 such as a pre-or post-workout powder. The container 58 may be sized to facilitate supporting the first and second support tabs 54, 56 to prevent the scoop apparatus 10 from falling into the reservoir 66. More specifically, the container 58 may have a size wherein the scoop apparatus 10 may be inverted and placed on the top edge 64 of the perimeter wall 62 of the container 58 via the first and second support tabs 54, 56. The inset nature of the first and second support tabs 54, 56 helps to keep the scoop apparatus 10 on the container 58 in that the bowl 22 and the handle 12 may abut an interior surface 68 of the container 58 when positioned over the container 58. Lateral movements with respect to the container 58 will then be limited. A lid 70 may threadedly or otherwise attach to the container 58 while the scoop apparatus 10 is positioned on the top edge 64, and the lid 70 may clamp onto the scoop apparatus 10 with the container 58.

To use the scoop apparatus 10 to deposit scoops of the substance 72 into a vessel 74 such as a water bottle or the like, the bowl 22 may be moved through a pile of the substance 72, then the funnel 30 may be attached to the bowl 22. The scoop apparatus 10 may then be upturned to deposit the scooped amount of the substance 72 into the vessel 74, using the funnel 30 to direct the substance 72 into the vessel 74.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A scoop apparatus comprising:
a handle, the handle being elongated between a first end and a second end, the handle having a bottom side and a top side which extend from the first end to the second end;
a bowl coupled to the handle at the second end thereof, the bowl defining a cavity which faces upwardly with respect to the handle, the bowl having a rim defining a bowl opening to the cavity; and
a funnel selectively mountable to the bowl, the funnel tapering from a receiving end to a dispensing end and defining a channel which extends through the receiving end and the dispensing end, the channel being in fluid communication with the cavity of the bowl when the funnel is mounted to the bowl, the funnel defining a dispensing opening at the dispensing end and a receiving opening at the receiving end, a width of the dispensing opening being smaller than a width of the bowl opening of the bowl.

2. The apparatus of claim 1, further comprising a retainer coupled to the funnel and configured to secure the funnel to the bowl, the retainer comprising a pair of securement tabs positioned at the receiving end of the funnel, the bowl defining a pair of slots for receiving the securement tabs, the securement tabs being positionable in the slots of the bowl to interlock with the bowl and retain the funnel on the bowl.

3. The apparatus of claim 2, wherein the securement tabs extend inwardly of the funnel, the slots being positioned in an exterior surface of the bowl, each slot of the pair of slots having a radial portion and a vertical portion, the vertical portion extending vertically with respect to the handle and being open at the rim of the bowl, the radial portion extending radially around the bowl.

4. The apparatus of claim 1, further comprising a first support tab and a second support tab, the first support tab being coupled to the handle at the first end, the second support tab being coupled to the bowl opposite the handle, the first and second support tabs extending in opposite directions from each other.

5. The apparatus of claim 4, wherein the first support tab is inset from the top side of the handle, the second support tab being inset from the rim of the bowl.

6. The apparatus of claim 1, wherein the bowl has a cylindrical shape.

7. A scoop apparatus comprising:
a handle, the handle being elongated between a first end and a second end, the handle having a bottom side and a top side which extend from the first end to the second end;
a bowl coupled to the handle at the second end thereof, the bowl defining a cavity which faces upwardly with respect to the handle, the bowl having a rim defining a bowl opening to the cavity, the bowl having a cylindrical shape;
a funnel selectively mountable to the bowl, the funnel tapering from a receiving end to a dispensing end and defining a channel which extends through the receiving end and the dispensing end, the channel being in fluid communication with the cavity of the bowl when the funnel is mounted to the bowl, the funnel defining a dispensing opening at the dispensing end and a receiving opening at the receiving end, a width of the dispensing opening being smaller than a width of the bowl opening of the bowl;
a retainer coupled to the funnel and configured to secure the funnel to the bowl, the retainer comprising a pair of securement tabs positioned at the receiving end of the funnel, the securement tabs extending inwardly of the funnel, the securement tabs being positioned opposite each other across the receiving opening, the bowl defining a pair of slots in an exterior surface of the bowl for receiving the securement tabs, each slot of the pair of slots having a radial portion and a vertical portion, the vertical portion extending vertically with respect to the handle and being open at the rim of the bowl, the radial portion extending radially around the bowl; and
a first support tab and a second support tab, the first support tab being coupled to the handle at the first end, the second support tab being coupled to the bowl opposite the handle, the first and second support tabs extending in opposite directions from each other, the first support tab being inset from the top side of the handle, the second support tab being inset from the rim of the bowl.

8. A storage and deposition assembly comprising:
a container for storing a substance, the container comprising a bottom wall and a perimeter wall, the perimeter wall being coupled to and extending upwardly from the bottom wall to a top edge, the container defining a reservoir surrounded by the bottom wall and the perimeter wall, the reservoir being configured to store the substance; and
a scoop apparatus positionable over the top edge of the perimeter wall comprising:
a handle, the handle being elongated between a first end and a second end, the handle having a bottom side and a top side which extend from the first end to the second end;
a bowl coupled to the handle at the second end thereof, the bowl defining a cavity which faces upwardly with respect to the handle, the bowl having a rim defining a bowl opening to the cavity;
a funnel selectively mountable to the bowl, the funnel tapering from a receiving end to a dispensing end and defining a channel which extends through the receiving end and the dispensing end, the channel being in fluid communication with the cavity of the bowl when the funnel is mounted to the bowl, the funnel defining a dispensing opening at the dispensing end and a receiving opening at the receiving end, a width of the dispensing opening being smaller than a width of the bowl opening of the bowl; and
a first support tab and a second support tab, the first support tab being coupled to the handle at the first end, the second support tab being coupled to the bowl opposite the handle, the first and second support tabs extending in opposite directions from each other, the first support tab being inset from the top side of the handle, the second support tab being inset from the rim of the bowl;
wherein the scoop apparatus is positionable in a storage position over the container, the storage position including the container being inverted such that the top edge of the perimeter wall of the container supports the first and second tabs of the scoop apparatus, the container having a width such that the bowl and the handle abut an interior surface of the container when the scoop apparatus is in the storage position.

9. The assembly of claim 8, wherein the scoop apparatus further comprises a retainer coupled to the funnel and configured to secure the funnel to the bowl, the retainer comprising a pair of securement tabs positioned at the receiving end of the funnel, the bowl defining a pair of slots for receiving the securement tabs, the securement tabs being positionable in the slots of the bowl to interlock with the bowl and retain the funnel on the bowl.

10. The assembly of claim 9, wherein the securement tabs extend inwardly of the funnel, the slots being positioned in an exterior surface of the bowl, each slot of the pair of slots having a radial portion and a vertical portion, the vertical portion extending vertically with respect to the handle and being open at the rim of the bowl, the radial portion extending radially around the bowl.

11. The assembly of claim 8, wherein the bowl of the scoop apparatus has a cylindrical shape.
